(19) United States
(12) Patent Application Publication
(10) Pub. No.: US 2026/0057464 A1
(43) Pub. Date: Feb. 26, 2026

(54) SYSTEMS AND METHODS FOR DISPUTE RESOLUTION WITH CONFIDENCE RATINGS

(71) Applicant: MASTERCARD TECHNOLOGIES CANADA ULC, Vancouver (CA)

(72) Inventors: Shrikant SALKE, Pune (IN); Aditya Nakka CHENCHU, Hyderabad (IN); Arnab MOITRA, Kolkata (IN); Jayesh UDANI, Saskatoon (IN); Jitesh GODWE, Pune (IN); Manoj Kishor BHOIR, Badlapur (IN); Rahul DESHPANDE, Chesterfield, MO (US); Sohini BASU, Dublin (IE); Supriya KUMTHEKAR, Pune (IN); Vijendra Pratap SINGH, Pune (IN)

(21) Appl. No.: 18/815,823

(22) Filed: Aug. 26, 2024

(51) Int. Cl. G06Q 50/18; G06Q 30/0283

(52) U.S. Cl. CPC G06Q 50/182; G06Q 30/0283

(57) ABSTRACT

Examples manage chargeback requests between issuers and acquirers. A method includes identifying an issuer and an acquirer involved in an active dispute case, computing a first count of wins for the issuer at a particular stage in a dispute resolution process using historical dispute cases; computing a number of resolved cases at the first stage; computing a win percentage for the issuer based on the first count of wins and the number of resolved cases; weight the win percentage; add the weighted win percentage with other weighted win percentages, thereby resulting in a dispute score; and transmitting the dispute score for display to one of the issuer and the acquirer, the dispute score representing a likelihood of one of the issuer and the acquirer in prevailing in the active dispute case over the other of the issuer and the acquirer.

### BACKGROUND

In a payment network, the payment dispute resolution process plays an important role in maintaining trust and security within payment networks and the banking and commerce industries. Chargebacks offer a vital protection mechanism for consumers (e.g., cardholders of payment cards), allowing them to dispute transactions and seek reimbursement for fraudulent or unsatisfactory purchases. However, despite these benefits, the dispute resolution process is laden with technical complexities and challenges that involve multiple parties and steps, which can complicate the handling of disputes.

The dispute resolution process typically commences when a consumer (e.g., a cardholder) detects a problematic transaction. The consumer contacts the bank that issued their payment instrument (the “issuing bank,” or just “issuer”) to file a chargeback request, typically within a window of 60 to 120 days from the date of the transaction. The issuing bank assesses the validity of the claim based on the provided evidence and the regulations of the pertinent payment network. If the claim is approved, the issuing bank temporarily credits the disputed amount back to the consumer's account and formally notifies the merchant's bank (the “acquiring bank,” or just “acquirer”). Upon receiving a chargeback notice, the merchant is faced with either accepting or contesting the chargeback. Contesting a chargeback involves the merchant compiling and submitting relevant evidence to their acquiring bank that supports the legitimacy of the transaction, such as delivery confirmation or service agreements. This evidence is relayed to the issuing bank, allowing the issuing bank to re-evaluate the dispute in light of the submitted evidence. Should the issuing bank maintain its support for the chargeback, the merchant typically has the option to seek arbitration through the payment network, a process that incurs additional costs and time.

This dispute resolution mechanism, while protective, introduces several risks and operational hurdles. For example, the process is vulnerable to abuse, notably in the form of “friendly fraud,” where consumers falsely dispute legitimate charges. It is difficult from a technical perspective to detect this kind of abuse. Such challenges not only lead to direct financial losses but also risk damaging the reputation of the merchant and their relationships with various financial institutions. Further, merchants must also navigate the intricate rules set by different payment networks and comply with varying regulatory standards across various jurisdictions. Failure to adhere to these rules and regulations can lead to disputes being automatically resolved in favor of the consumer, compounding the challenges for the merchant.

Payment networks also encounter several technical challenges related to the dispute resolution process. High rates of disputes involve additional administrative efforts to handle disputes and ensure compliance with network regulations. Persistent high dispute ratios within a payment network may reflect issues with member banks or merchants, potentially impacting the reputation of the payment network for security and efficient processing. Moreover, the payment network also consumes computing resource to facilitate this dispute resolution process.

### SUMMARY

Some examples provide a dispute scoring system. The dispute scoring system includes at least one processor; and at least one memory comprising computer-readable instructions, the at least one processor, the at least one memory and the computer-readable instructions configured to cause the at least one processor to: identify a first party and a second party involved in an active dispute case involving a payment instrument transaction; generate, from a plurality of historical dispute cases between the first party and the second party, a first count of wins for the first party at a first stage in a dispute process; generate, from the plurality of historical dispute cases, a number of resolved cases at the first stage; compute a first stage win percentage for the first party based on the first count of wins and the number of resolved cases; weight the first stage win percentage by a first weight value assigned to the first stage, thereby resulting in a weighted first stage win percentage; combine the weighted first stage win percentage with at least one other weighted win percentage for at least one other stage, thereby resulting in a dispute score; and transmit the dispute score for display to one of the first party and the second party, the dispute score representing a likelihood of one of the first and second party in prevailing in the active dispute case over the other of the first and second party.

Some examples provide a computer-implemented method that includes: identifying an issuer and an acquirer involved in an active dispute case involving a payment instrument transaction; causing to be computed, from a plurality of historical dispute cases between the issuer and the acquirer, a first count of wins for the issuer at a first stage in a dispute process; causing to be computed, from the plurality of historical dispute cases, a number of resolved cases at the first stage; causing to be computed a first stage win percentage for the issuer based on the first count of wins and the number of resolved cases; modifying the first stage win percentage by multiplying by a first weight value assigned to the first stage, thereby resulting in a weighted first stage win percentage; adding the weighted first stage win percentage with at least one other weighted win percentage for at least one other stage, thereby resulting in a dispute score; and transmitting the dispute score for display to one of the issuer and the acquirer, the dispute score representing a likelihood of one of the issuer and the acquirer in prevailing in the active dispute case over the other of the issuer and the acquirer.

Some examples provide a computer storage medium having computer-executable instructions that, upon execution by a processor of a computer, cause the processor to at least: identify a first party and a second party involved in an active dispute case involving a payment instrument transaction; generate, from a plurality of historical dispute cases between the first party and the second party, a first count of wins for the first party at a first stage in a dispute process; generate, from the plurality of historical dispute cases, a number of resolved cases at the first stage; compute a first stage win percentage for the first party based on the first count of wins and the number of resolved cases; weight the first stage win percentage by a first weight value assigned to the first stage, thereby resulting in a weighted first stage win percentage; combine the weighted first stage win percentage with at least one other weighted win percentage for at least one other stage, thereby resulting in a dispute score; and transmit the dispute score for display to one of the first party and the second party, the dispute score representing a likelihood of one of the first and second party in prevailing in the active dispute case over the other of the first and second party.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an architecture diagram illustrating an example dispute resolution system that is used to evaluate active payment disputes (e.g., “chargebacks”) between issuing and acquiring banks.

FIG. 2 is an example table that is used as the scoring model to generate the dispute score for a dispute, such as the example chargeback of FIG. 1.

FIG. 3 is a flowchart of an example process for generating and displaying the dispute score for the chargeback request associated with a disputed transaction, such as the example shown in FIG. 1.

FIG. 4 is a diagram of an example graph that displays the dispute score on a dispute meter.

FIG. 5 is a screenshot of an example dashboard that shows several example disputes and associated data.

FIG. 6 is another screenshot of the dashboard in which the issuer initiates an arbitration case for a dispute, such as the example chargeback request of FIG. 1.

FIG. 7 is a flowchart of an example method for analyzing and scoring chargeback cases between parties, such as the issuer and the acquirer of FIG. 1.

FIG. 8 illustrates a computing apparatus according to an embodiment as a functional block diagram.

Corresponding reference characters indicate corresponding parts throughout the drawings. Any of the figures may be combined into a single example or embodiment.

### DETAILED DESCRIPTION

The dispute resolution process for payment transactions can be a lengthy and computing resource-intensive process for all stakeholders involved (e.g., issuer, acquirer, merchant, consumer). Each stage in the dispute resolution process consumes additional computing resources. At each stage, some or all of the stakeholders have an opportunity to consider whether or not to continue pursuing their position in the dispute. However, it can be difficult for stakeholders to assess their chances in eventually prevailing in that particular dispute without a technical solution.

An example dispute resolution system is provided to provide a technical solution to computational difficulties involved in current dispute resolution processes. Aspects of the disclosure generate a dispute score for a particular dispute based on particular data associated with that dispute (e.g., dispute amount or win percentage between the issuing and acquiring banks). This dispute score represents how likely one party or the other is to succeed in the dispute. This dispute score is presented to any or all of the parties, thus helping the stakeholders to resolve disputes in fewer dispute stages. This quick resolution reduces the number of technical and operational resources expended by the various parties to resolve disputes. As such, aspects of the disclosure improve computing resource usage and the functioning of the underlying devices involved in resolving the disputes.

More specifically, in some examples, the dispute resolution system generates the dispute score by analyzing numerous historical disputes between the issuer and the acquirer, identifying a win percentage for the issuer at each stage of the dispute process. The win percentage at each stage is weighted based on the resources typically expended to resolve disputes at that stage (e.g., time, money, disputed amount). These weighted win percentages for each of the stages are summed to generate the dispute score, which represents an overall chance to win this dispute. The dispute score is displayed to the stakeholders, thereby allowing the parties to assess their prospects at any particular stage in the dispute.

The conventional computing device operates in an unconventional manner at least by analyzing historical transaction dispute cases between issuers and acquirers, computing win counts for the issuer, a number of resolved cases, and win percentages at various stages in the dispute process. These win percentages are weighted with individual weights for each stage to generate weighted win percentages. These weighted win percentages are summed to generate a dispute score for a particular dispute. The dispute score is transmitted to the issuer and/or the acquirer for display, thereby allowing the vested parties to make informed decisions regarding whether to continue pursuing that particular disputed transaction. The dispute resolution system eliminates many computational stages and network traffic that would otherwise occur (e.g., during a prolonged dispute) by allowing the parties to identify when their chances of prevailing in the particular dispute is low. When one of the vested parties receives a low dispute score from the system, they may concede the dispute at an earlier stage, thereby reducing computational burden on the system.

The term “chargeback” may be used herein to refer to the dispute resolution process for a disputed transaction, or to a particular stage of that dispute resolution process (e.g., the “chargeback” stage). Further, while many of the examples described herein are provided in the context of a payment card transaction associated with a payment card of a cardholder, it should be understood that the dispute resolution process can apply to other payment instruments and associated payment systems (e.g., alternative payment methods (APMs), 4+ party payment systems, cryptocurrency systems, or the like), and thus the systems and methods described herein can likewise be applied to such other payment instruments.

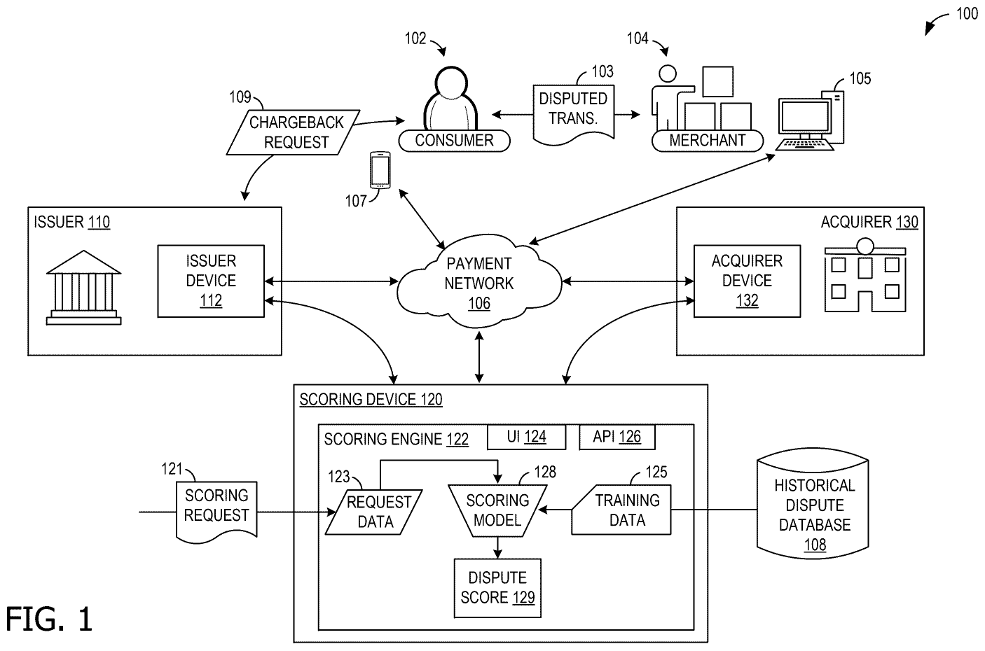

FIG. 1 is an architecture diagram illustrating an exemplary dispute resolution system 100 that is used to evaluate active payment transaction disputes (e.g., “chargebacks”) between issuing and acquiring banks. In examples, the dispute resolution system 100 provides a scoring device 120 that facilitates dispute resolution between an issuing bank (or just “issuer”) 110 and an acquiring bank (or just “acquirer”) 130. The scoring device 120 utilizes a scoring model 128 to generate a dispute score 129 for each individual dispute, typically initiated via a chargeback request (or just “chargeback”) 109. This dispute score 129 is a representation of the likelihood that the result of the dispute will go in favor of the issuer 110 or in favor of the acquirer 130.

In the example, an initial transaction (or “disputed transaction”) 103 is performed with a merchant 104 using a payment card (not separately shown) of a consumer 102 (e.g., a cardholder of a payment card, or the like). This transaction 103 causes the issuer 110 to send a payment for the transaction 103 to the merchant 104 via a payment network 106 (e.g., using a cardholder account at the acquirer 130). In some examples, this transaction 103 is a fraudulent transaction performed by some nefarious actor (not shown) (e.g., using stolen payment card data), and thus becomes disputed, for example, when the consumer 102 realizes a fraudulent transaction has been performed using their payment card. In other examples, this transaction 103 is performed by the consumer 102, but the transaction 103 becomes disputed by the consumer 102, for example, if the merchandise is not received, if the merchandise is defective or not as described, if there is a duplicate transaction, if a refund was promised by the merchant but not received, if the transaction 103 was for an incorrect amount, if the transaction 103 was a recurring transaction that had previously been cancelled by the consumer 102, if the transaction 103 paid for services that were not provided, if the merchant violated terms of an agreement regarding the transaction 103, if the consumer 102 returned an item but was not properly credited by the merchant 104, or the like.

In this example, for whatever the reason, it is presumed that the consumer 102 is disputing the transaction 103. As such, in some situations, the consumer 102 may request a refund from the merchant 104 (e.g., prior to initiating a formal chargeback request with the issuer 110). However, the merchant 104 denies the refund in this example, and thus the consumer 102 initiates the chargeback 109 with the issuer 110 (e.g., as shown in FIG. 1).

The dispute resolution process typically consists of several stages, beginning with the filing of the chargeback 109 by the consumer 102. While this example describes the filing of the chargeback 109 as the beginning of the dispute resolution process, as this is the first dispute action that directly involves the payment network 106 and the rating device 120, it should be understood that this dispute resolution process may include some interactions between the consumer 102 and the merchant 104 or acquirer 130, some of which may lead to resolution prior to submission of the chargeback request 109 (“pre-chargeback” stages, sometimes referred to as “collaboration”). In the example, at this first stage (also referred to herein as the “chargeback stage”), the issuer 110 has received the chargeback request 109 from the consumer 102. The issuer 110 evaluates the chargeback 109 based on initial information provided (e.g., product details, consumer details, transaction details, account or cardholder statement) to determine if the request is valid (e.g., appears to be a fraudulent transaction, not a mistake in understanding by the consumer 102, meets chargeback requirements, or the like). Upon determining that the chargeback 109 appears valid, the consumer 102 is provisionally refunded (e.g., for all or some of the amount of the disputed transaction 103) and the acquirer 130 associated with the chargeback 109 is notified (e.g., via the issuer 110 sending a chargeback notification (not shown) to the acquirer 130, and with funds moving from acquirer 130 to issuer 110). The chargeback notification includes details of the disputed transaction and the reason for the chargeback.

At this stage in the dispute resolution process, the acquirer 130 has received the chargeback notification and may inform the merchant 104 of the disputed transaction 103. The acquirer 130 reviews the chargeback details and works with the merchant to gather evidence and documentation to respond to the chargeback. The acquirer 130 and/or the merchant 104 has the option to contest the chargeback 109 or to concede. In some examples, the acquirer 130 may concede the chargeback 109 in situations where the evidence is obvious (e.g., for technical errors such as duplicate transactions or incorrect transaction amount, for authorization issues such as where the transaction was processed without proper authorization, if the acquirer 130 has clear evidence that the underlying goods or services were not delivered or provided, if the merchant 104 clearly violated their agreement terms, if there is clear and compelling evidence that the transaction was fraudulent, if the data provided for the chargeback 109 makes it apparent that contesting would be futile, or the like).

In this example, the acquirer 130 and/or the merchant 104 decides to contest the chargeback request 109, and thus the dispute resolution process continues to a second stage, the “re-presentment stage.” Re-presentment is initiated by the acquirer 130 to contest the chargeback 109 and includes “re-presenting” the transaction as a valid transaction, along with possibly any evidence collected about the transaction 103, thereby continuing the dispute. Once the transaction 103 has been re-presented, this causes the funds for the disputed transaction 103 to move from the issuer 110 back to the acquirer 130.

In a third stage of the dispute resolution process, a “pre-arbitration stage,” the issuer 110 can initiate a pre-arbitration case if they still want to proceed with the dispute. The issuer 110 and acquirer 130/merchant 104 exchange evidence and the acquirer 130 decides if they accept the chargeback 109 (e.g., concede the dispute, causing funds to move back from acquirer 130 to issuer 110) or proceed to arbitration. During this stage, the merchant 104 gathers evidence to contest the chargeback 109 if they believe the transaction 103 was legitimate. Such evidence can include, for example, transaction records (e.g., point-of-sale (POS) receipts, online transaction records, showing date, amount, details of the transaction, and so forth), proof of delivery (e.g., tracking numbers and delivery confirmation from shipping carriers showing that the goods were delivered to the consumer 102), product or service descriptions (e.g., advertisements, service agreements that clearly describe what the consumer 102 purchased), customer communications (e.g., email correspondence, chat logs, or the like between the consumer 102 and the merchant 104, particularly those related to the transaction, delivery, or any disputes raised by the consumer 102), merchant policies documentation (e.g., documentation of refund, return, or cancellation policies of the merchant 104, along with evidence that these policies were communicated to the consumer 102 prior to the transaction), proof of refunds documentation (e.g., records of any refunds or partial refunds that were issued to the consumer 102, including transaction IDs and dates of the refunds), customer authorization documentation (e.g., details of any authentication measures used during the transaction, such as Address Verification Service (AVS) results, Card Verification Value (CVV) checks, 3D Secure authentication, or the like), customer usage evidence (e.g., proof that the consumer 102 used the purchased goods or services, such as login records for digital services, usage logs, or evidence of items being worn or used), recurring payment agreement documentation (e.g., copies of agreements or terms and conditions for recurring payments or subscriptions, along with evidence of acknowledgement and acceptance of the terms by the consumer 102), and photographic evidence (e.g., photos of the delivered items, particularly if the dispute involves claims of damage or that items were not as described). By gathering and presenting this evidence during the dispute, the merchant 104 aims to demonstrate that the transaction was legitimate and that the goods or services were provided as agreed. This evidence is submitted to the acquirer 130 and shared with the issuer 110 for review, giving both parties the option to concede the dispute or continue.

During a fourth and final stage of the dispute resolution process, in the example, the dispute is ultimately resolved via an arbitration process. If the pre-arbitration case is rejected by the acquirer 130, then the issuer 110 can escalate the dispute to this arbitration stage. In examples, the arbitration process can include numerous sub-stages. The acquirer 130 and merchant 104 then have another opportunity to provide additional evidence or negotiate a settlement with the consumer 102. If the merchant 104 provides additional evidence, it is reviewed by the issuer 110. In this example, the payment network 106 acts as the arbitrator, reviewing all evidence provided by both parties after receipt of a formal arbitration filing by the requesting party (along with an arbitration fee). An arbitration team of the payment network 106 reviews the case, evaluates the evidence, and makes a final decision based on rules and regulations promulgated by the payment network 106, and that decision is binding and final. Accordingly, the chargeback 109 is either upheld or reversed based on the ruling. If the chargeback 109 is upheld, the consumer 102 retains the refunded amount, and the merchant 104 is responsible for the chargeback amount and any associated fees. If the chargeback 109 is reversed, the consumer 102 is re-debited for the transaction amount, and the merchant retains the funds. Arbitration is usually considered a last resort due to the costs and time involved.

As depicted above, the dispute resolution process can be a lengthy, long, and costly process. For the merchant 104, the process can result in financial losses from refunding the disputed transaction 103, but also additional dispute resolution fees, and potential penalties for excessive chargebacks (which can damage their reputation and relationships with acquiring banks). Further, the merchant 104 also faces operational burdens such as, for example, spending significant time and resources gathering evidence and managing disputes. For the consumer 102, disputes can lead to frustration and inconvenience, particularly if the dispute resolution process is prolonged or if their claims are not upheld. For the issuer 110 and acquirer 130, they incur operational costs related to processing disputes, including staffing and administrative expenses for handing disputes and reviewing evidence. The issuer 110 and acquirer 130 also faces potential reputational damage if consumers or merchants perceive the dispute resolution process as slow or unfair. High volumes of disputes can strain human and computational resources as well as reduce operational efficiency. Further, issuers 110 and acquirers 130 may absorb financial losses if disputes are not recovered from the merchants or if fraudulent disputes go undetected. Ensuring compliance with complex and evolving dispute resolution regulations and rules of the payment network 106 adds to the operational burden, often leading to additional training and updates to internal processes.

To aid in evaluating this dispute (e.g., the chargeback 109), the issuer 110 and acquirer 130 utilize the scoring device 120 to evaluate the dispute resolution process for the chargeback 109 at various stages during the process. The scoring device 120 includes a scoring engine 122 that is configured to generate a dispute score 129 based on the dispute history between the issuer 110 and acquirer 130. At any given stage, this dispute score 129 is a representation of the likelihood that the result of the dispute will go in favor of the issuer 110 or in favor of the acquirer 130 (e.g., with a higher score indicating favorability to the issuer 110/consumer 102 and a lower score indicating favorability toward the acquirer 130/merchant 104). As such, the dispute score 129 allows the parties to assess their chances of prevailing at any given stage, thereby helping to inform their decisions regarding whether the costs of continuing the dispute (e.g., in time, financial costs, computational resources, human resources) is worth the potential results. In some examples, the dispute score may be presented to the merchant 104 early in the dispute process (e.g., before the chargeback request 109 is initiated by the consumer 102), thereby allowing the merchant 104 to assess their position and perhaps avoid the chargeback request 109 at an early stage.

More specifically, the scoring engine 122 receives a scoring request message 121 that includes request data 123 related to the chargeback request 109 (e.g., merchant 104, disputed amount, acquirer 130, issuer 110). This scoring request 121 represents a request to generate the dispute score 129 for this dispute and the disputed transaction 103 (e.g., the chargeback request 109). The scoring engine 122 uses training data 125 from a historical dispute database 108 to build a scoring model 128. In examples, the scoring model 128 is constructed as a set of values that reflect historical dispute results between the issuer 110 and the acquirer 130 at the various dispute stages (e.g., how often the issuer 110 won at a particular stage over the acquirer 130). The values of the scoring model 128 are calculated using training data 125 from a historical dispute database 108, where the historical database 108 tracks details for disputes between this issuer 110 and acquirer 130, as well as numerous other issuers and acquirers. Such details for disputes can include, for example, unique IDs for the parties involved (e.g., particular issuer 110, acquirer 130, merchant 104, consumer 102 involved in the dispute), amount of the disputed transaction 103, a resolution stage (e.g., the particular stage at which the dispute was resolved), fees, expenses, and/or losses incurred by the various parties during the dispute, and the like.

In examples, the scoring engine 122 searches through all dispute records in the historical dispute database 108 and retrieves the dispute records that match the request data 123 for this particular chargeback 109 (e.g., disputes between this particular issuer 110 and acquirer 130 or merchant 104). From these dispute records, the scoring engine 122 then computes the values that make up the scoring model 128. In examples, the scoring model 128 is constructed as a table (not separately shown in FIG. 1) in which individual rows represent particular stages of the dispute process, columns represent a particular metric of interest, and where each cell thus represents a computed value for a particular metric (column) at that particular stage (row). For example, one row may represent the first stage as described above (e.g., after the chargeback 109 has been filed with the issuer 110 but before the issuer 110 sends the chargeback 109 to the acquirer 130). The columns may include, for example, a total number of disputes won by the issuer 110 at this stage, a total number of disputes resolved at this stage, a total number of disputes resolved at or before this stage, and an issuer win percentage. As such, the values appearing in the scoring model 128 are computed by the scoring engine 122 using the training data 125.

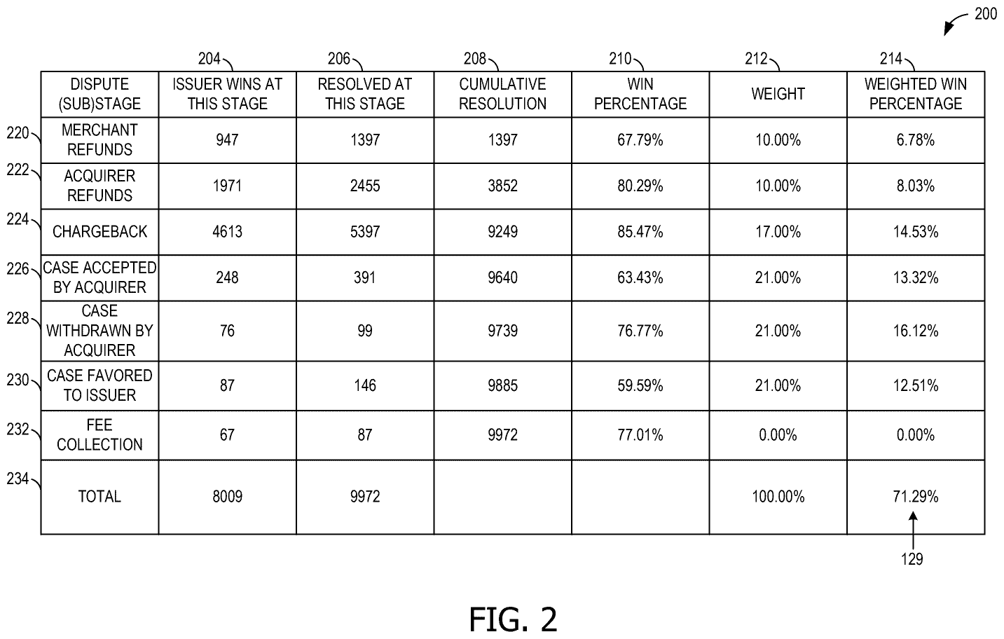

In the example, the scoring engine 122 calculates the dispute score 129 using the scoring model 128. More specifically, for each stage in the dispute resolution process (e.g., for each row of the table), a raw win percentage is calculated based on (1) the number of issuer wins at that stage and (2) the total number of disputes resolved at that stage (e.g., as identified in the training data 125, and perhaps as already populated in one or more columns of that row). To generate the dispute score 129, the scoring model 128 assigns each stage in the dispute resolution process a weight (e.g., a predetermined value, perhaps configured based on relevance of that particular stage), where all weights sum up to one hundred percent. In examples, weight is another column in the table. In some examples, stages in the dispute that use more resources are weighted higher than those with a low resource cost. For each stage, the scoring engine 122 calculates a weighted win percentage by multiplying the weight of that particular stage with the raw win percentage of that stage. With the weighted win percentage calculated for all stages, the scoring engine 122 sums up the weighted win percentages to calculate a composite weighted win percentage. In some examples, the composite weighted win percentage is the dispute score 129. In this example, the scoring engine 122 scales this composite weighted win percentage to get the dispute score 129. More specifically, the composite weighted win percentage is mapped to a range of 0 to 999 (e.g., multiplying the composite weighted win percentage by 10), with 0 being the lowest chance of a win for the issuer 110 in the dispute and 999 being the highest chance of a win for the issuer 110 in the dispute. An example of the scoring model 128 and the associated values is discussed in further detail below with regard to FIG. 2.

In examples, the dispute score 129 and other useful information (e.g., win percentage at each stage) is provided to the stakeholders (e.g., issuer 110, acquirer 130) via a user interface (UI) 124 and/or an application programming interface (API) 126, allowing the stakeholders to evaluate predictions on who is more likely to be successful in this dispute and in which stage the dispute is more likely to be resolved in. The UI 124 may be presented as a website, a desktop program, or the like, which may interface with the API 126. This UI 124 is accessed by the issuer device 112, the acquirer device 132, the merchant device 105, and the consumer device 107. These devices may take the form of a personal smartphone, computer, tablet, or the like. In some examples, the UI 124 may allow the user (e.g., of the issuer 110, acquirer 130, merchant 104, consumer 102) to identify which historical disputes to use to compute the dispute score 129 (e.g., via selection of filtration criteria for records from the historical dispute database 108), perhaps allowing the user to tailor the scoring to historical disputes more similar to the current situation.

In some examples, the scoring device 120 calculates a score of 850 for this example chargeback 109. In addition, the scoring device 120 also identifies that the acquirer 130 has a strong likelihood to win the dispute in a pre-arbitration stage (e.g., a low win percentage for the issuer 110 at that stage). As such, in the pre-arbitration stage, the acquirer 130 submits evidence to the issuer 110 to reevaluate the case. In some examples the issuer 110 or acquirer 130 may have instituted automatic resolution rules based on the dispute score 129 that may come into effect. For example, these rules could include automatic concession by the issuer 110 if the dispute score 129 is lower than a particular amount, or an automatic concession by the acquirer 130 if the dispute score 129 is higher than another particular amount. In this example, the acquirer 130 has an overall likelihood of losing the case but a stronger likelihood to win before arbitration. As such, the acquirer 130 decides to continue with the dispute and submits the evidence it has gathered to the issuer 110. The issuer 110, upon reviewing the evidence the acquirer 130 has provided, decides not to concede the case and to continue forward. At this stage, the issuer 110 has a strong likelihood of winning based on the dispute score 129 and, as such, the acquirer 130 may decide to concede the case.

FIG. 2 is an example table 200 that is used as the scoring model 128 to generate the dispute score 129 for a dispute, such as the example chargeback 109 of FIG. 1. In the example, each row of the table 200 represents a stage or sub-stage of the dispute resolution process such as the chargeback 109 shown in FIG. 1 that are in favor of the issuer 110, and each column of the table 200 represents some metric used by the scoring engine 122 during computation of the dispute score 129. As such, each cell in the table 200 represents a computed value for that particular metric (column) at that particular stage (row) (e.g., using the training data 125 from the historical dispute database 108 as between the issuer 110 and acquirer 130, as described above).

Referring to the rows 220-234 of the table 200, in the example, each of the rows 220-232 of the table 200 represent a stage or sub-stage of the dispute resolution process for the chargeback 109. These rows 220-234 include a merchant refunds stage 220, an acquirer refunds stage 222, a chargeback stage 224, a case accepted by acquirer stage 226, a case withdrawn by acquirer stage 228, case favored to issuer stage 230, and a fee collection row 232, as well as a total row 234 (i.e., not a stage, but rather optionally some total value for that column/metric). The various dispute stages 220-232 are shown in approximately chronological order in the dispute process, with earlier stages being shown above later stages. It is presumed, in these examples, that if the issuer does not win at some particular stage 220-232 and does not concede, then that dispute continues on to a subsequent (lower) stage. Further, it should be noted that not all stages or sub-stages of the dispute resolution process are shown as distinct rows 220-234 in FIG. 2. Rather, the rows 220-234 represent the stages at which the issuer 110 wins (or concedes) some cases.

More specifically, merchant refunds stage 220 represents a stage in which chargeback 109 had been filed and, in the case of a win for the issuer, the merchant refunds the disputed transaction shortly after notification of the chargeback 109 (e.g., without escalating the case with the acquirer, without gathering and submitting evidence, or the like). Acquirer refunds stage 222 represents a stage in which the acquirer has received notice of the chargeback and, in the case of a win for the issuer, concedes the dispute (e.g., based on their own evidence or merchant evidence). Chargeback stage 224 represents a stage in which the chargeback 109 is disputed between the issuer and acquirer/merchant (e.g., exchanging and evaluating evidence) where, in the case of an issuer win, the acquirer/merchant concedes without proceeding to file an arbitration case. Case accepted by acquirer stage 226 (and subsequent stages) represents the beginning of an arbitration case, where the arbitration case has been accepted by the acquirer. Case withdrawn by acquirer stage 228 represents a withdrawal of the arbitration case by the acquirer (and thus a win for the issuer/consumer). Case favored to issuer stage 230 represents a stage in which the arbitrator has ruled in favor of the issuer (in cases where the issuer is the winner) or for the acquirer (in other cases).

Referring to the columns 204-214 of the table 200, in the example, the table 200 includes an issuer wins at this layer column 204, a resolved at this stage column 206, a cumulative resolution column 208, a win percentage column 210, a weight column 212, and a weighted win percentage column 214. The issuer wins at this layer column 204 contains the total number of wins for the issuer 110 at each stage (e.g., each row 220-232). The resolved at this layer column 206 contains the total number of disputes resolved at each stage. As such, the difference between the values of column 206 and column 204 represents the number of wins for the acquirer 130. The cumulative resolution column 208 contains the number of disputes resolved at each stage and all previous stages. The win percentage column 210 contains the calculated win percentage for each stage (e.g., column 204 divided by column 206). The weight column 212 contains the percentage weights for each stage (e.g., a predefined set of weights). The weighted win percentage column 214 contains the calculated weighted win percentages for each stage (e.g., column 210 times column 212).

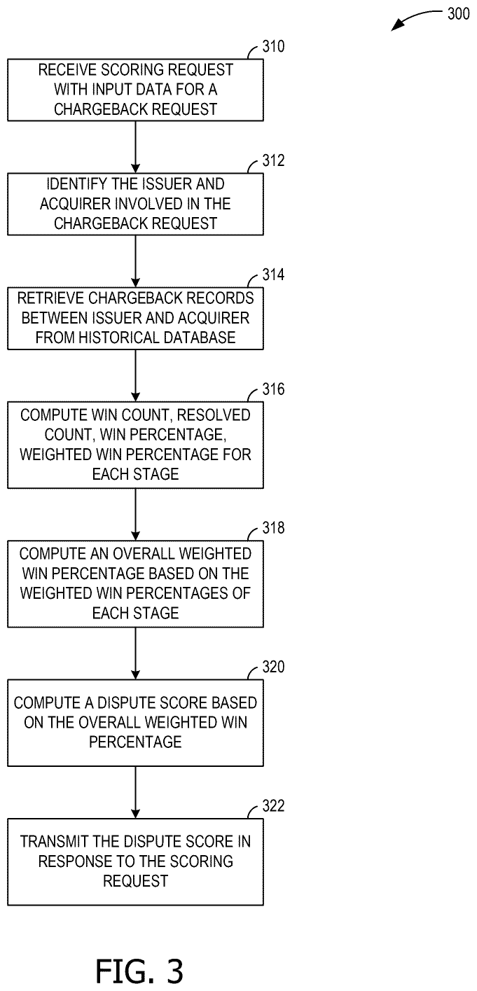

FIG. 3 is a flowchart of an example process 300 for generating and displaying the dispute score 129 for the chargeback request 109 associated with a disputed transaction 103 of FIG. 1. In some examples, the operations of process 300 are performed by the scoring engine 122 of the scoring device 120 shown in FIG. 1. In the example, at operation 310, the scoring engine 122 receives a scoring request 121 that includes request data 123 associated with the chargeback request 109 (e.g., details about the disputed transaction, IDs of the issuer 110, acquirer 130, merchant 104, and/or consumer 102, ID of the chargeback request 109, ID of the disputed transaction 103, or the like). In some examples, the scoring request is received via the API 126 or the UI 124 shown in FIG. 1. At operation 312, the scoring engine 122 identifies the identifies the issuer and acquirer involved in the chargeback request 109 (e.g., by unique issuer ID, unique acquirer ID, or the like, as included in the request data 123).

In the example, at operations 314-316, the scoring engine 122 constructs the scoring model 128 shown in FIG. 1 (e.g., the table 200 shown in FIG. 2). More specifically, at operation 314, the scoring engine 122 retrieves records of disputes between the issuer 110 and the acquirer 130 from the historical dispute database 108. In examples, these records include, for example, at what stage each historical dispute request was resolved and in which party's favor, and/or other filtration criteria. At operation 316, and using the retrieved records, the scoring engine 122 computes a win count (e.g., issuer wins at this stage 204), a resolved count (e.g., resolved at this stage column 206), a win percentage (e.g., win percentage 210), and a weighted win percentage (e.g., weighted win percentage 214) for each stage. In some examples, the scoring engine 122 also computes a cumulative resolution count for each stage (e.g., cumulative resolution 208, more particularly, the sum of all resolved at this stage column 206 values for this and all earlier stages).

In some examples, operation 314 includes filtering the retrieved records of disputes between the issuer 110 and the acquirer 130 from the historical dispute database 108 based on one or more additional filtration criteria (e.g., filter parameters). Such additional filtration criteria may include any or all of the following: identifiers for the involved parties (e.g., Acquirer ID, Issuer ID, Processor ID, Merchant ID), partial account numbers (e.g., first 8 digits of PAN, digit 2 to 6 of ARN, as certain lines of business on the issuing side and acquiring side are segregated and thus may have different dispute scores), transaction amount thresholds or ranges (e.g., low value, mid value, high value disputes and dispute ranges are likely to be handled in different ways and by different parties, and thus may warrant different dispute scores), temporal ranges (e.g., filtered on weekly, monthly, quarterly, yearly, holiday seasons, year end, or the like, date ranges), by geography (e.g., different geographies may handle disputes differently, or may have different rules or laws governing dispute resolution, and thus may warrant distinct dispute scores, inter-regional, intra-country, intra-regional, member-to-member, and the like), by reason code (e.g., different reason codes for raising disputes, such as fraud, non-fraud, merchant mistake, and the like), card brand (e.g., issuer segments may have different behaviors, where some might be more prone to first person fraud, some might not care for small value transactions, and might help differentiate between commercial and retail), card acceptor code (e.g., merchant category code (MCC), where some merchant businesses might be more prone to fraud-related disputes, such as betting, gambling, dating), processing code (e.g., type of transactions might be relevant to issuers or acquirers, such as cash withdrawals being more important to acquirers), authorization response codes (e.g., indicating approval or decline of transaction and reason for rejection and possible action item for the acceptor), card present indicator and/or cardholder present indicator (e.g., indicating the presence of the payment card and/or the cardholder at the point of service of the transaction), and POS entry mode (e.g., indicating the method used for PAN entry to initiate the transaction).

In some situations, this query for historical dispute cases may be overly narrow, or the number of cases resulting from the query may be low enough such that reliance on the scoring generated using this small sample size may lead to unreliable or inconsistent results. As such, in some examples, the scoring engine 122 implements a filtration threshold using the number of historical dispute cases identified in this query (e.g., after applying the particular filtration criteria identified for this query). When the number of historical dispute cases generated by the query is below the filtration threshold (e.g., too small of a sample size), the scoring engine 122 automatically selects one or more of the filtration criteria from the prior query and removes that criteria from the query, resubmitting the updated query to the historical dispute database 108. In some examples, the scoring engine 122 may prompt the user to edit the prior filtration criteria and select which criteria to remove from the query, and may display the number of cases generated by the prior criteria list and/or the number of cases generated by an updated criteria list, thereby allowing the user to evaluate the results of their decisions before proceeding with use of the generated score. Such automatic or user-driven filtration modification may continue until the filtration threshold is exceeded (e.g., until the number of generated cases is greater than or equal to the filtration threshold).

In some examples, the scoring engine 122 may generate one or more database queries that are configured to cause the historical dispute database 108 to perform some or all of these computations. For example, one or more database queries may be configured to select records that involved both the issuer 110 and the acquirer 130 (e.g., by unique ID) and that were resolved at a particular stage, and may include any or all of the filtration criteria identified above. From this subset of records, a count of those records that were resolved in favor of the issuer 110 yields the value in the issuer wins at this stage column 204, and a total count of these records is the value in the resolved at this stage column 206. As such, this computational complexity can be distributed to whatever computational resource is executing the historical dispute database 108, further limiting the amount of data transmitted between the database 108 and the scoring device 120.

Further, while the examples described herein frame many of the values from the perspective of the issuer 110 (e.g., issuer wins, issuer win percentage), it should be understood that, in such disputes, either the issuer 110 prevails or the acquirer 130 prevails. As such, the scoring engine 122 may, additionally or alternatively, generate values from the perspective of the acquirer 130 (e.g., acquirer wins, acquirer win percentage). For example, in merchant refunds stage 220 of FIG. 2, the example number of issuer wins at this stage 204 is 947 and the total resolved at this stage column 206 is 1,397. As such, the acquirer wins at this stage is the total resolved at this stage less the issuer wins (e.g., 1,397−947=450 acquirer wins), and thus the acquirer win percentage at this stage is 450/1,397=32.21% (or 100%−67.79%=32.21).

At operation 318, the scoring engine 122 computes an overall weighted win percentage based on the weighted win percentages of each stage (e.g., the value from the totals row 234 in the weighted win percentage column 214). In the example shown in FIG. 2, the overall weighted win percentage is 71.29% (from the perspective of the issuer 110). At operation 320, the scoring engine 122 computes the dispute score 129 based on this overall weighted win percentage (e.g., normalizing or scaling the overall weighted win percentage onto a 0 to 999 range). At operation 322, the scoring engine 122 transmits the dispute score 129 to the requester (e.g., the issuer device 112, the acquirer device 132) for display to one or more of the parties. In some examples, the scoring engine 122 also transmits one or more other computed values to the requester (e.g., any or all of the values shown in table 200).

In some examples, the dispute score 129 is computed as the sum of weighted win percentages across a plurality of layers. In some examples, the dispute score 129 is computed as:

$$dispute score = {\sum }_{1}^{n} {W}_{n} * \frac{{C}_{n}}{{R}_{n}} , \qquad ( 1 )$$

where n is the number of dispute stages, Wₙ is the weight assigned to stage n (e.g., from weight column 212), Cₙ is the count of disputes won at stage n (e.g., from issuer wins at this stage column 204), and Rₙ is the total number of disputes resolved at stage n (e.g., from resolved at this stage column 206). In examples, the issuer win scenarios include refund by merchant, refund by acquirer, dispute resolved at first chargeback (e.g., no subsequent re-presentment by acquirer), case accepted by acquirer, case withdrawn by acquirer (e.g., pre-comp), DRM favored issuer, and fee collection (e.g., no subsequent cycle created by acquirer). Acquirer win scenarios include re-presentment created with no case filed, case accepted by issuer, case withdrawn by issuer, DRM favored acquirer, fee collection (e.g., no subsequent cycle created by issuer), and transaction categorized as a first party fraud. Further, in examples, the scoring engine 122 excludes false negatives and/or false positives, where false negatives include disputes refunded by account managers through manual intervention, and where false positives include disputes which have processing issues (e.g., if chargeback was created by customer but it was not loaded into system during processing, such is not considered until the issue is resolved).

In some examples, the training data 125 is normalized using min-max scaling to rescale these numeric values within a certain range (e.g., 0.1 to 1,000) without distorting the differences in the ranges of the original data. For example, if X is the original input parameter(s), then the normalized input parameter(s), Xₙₒᵣₘ, is calculated as:

$${X}_{norm} = \frac{X - {X}_{min}}{{X}_{max} - {X}_{min}} * ( ( {Weight}_{max} - {Weight}_{min} ) + {Weight}_{min} ) ,$$

where Xₘᵢₙ and Xₘₐₓ are the minimum and maximum value of the original parameter, respectively, and where Weightₘᵢₙ and Weightₘₐₓ are the minimum possible and maximum possible (starting) dispute weights, respectively (e.g., 0.1 or 10%, 0.5 or 50%, respectively) (where Weightₘᵢₙ ensures that each layer is contributing a significant amount to the dispute score, and where Weightₘₐₓ ensures that no layer is completely dominating the dispute score).

For example, consider the following Table 1 of scoring inputs before normalization:

TABLE 1
Scoring Inputs Before Normalization

| | Average Dispute | Count of all | Fees to |
|---|---|---|---|
| | Amount of all | Disputes | resolve the |
| | Disputes | Resolved | Dispute |
| Stage₁ | a₁ | c₁ | f₁ |
| Stage₂ | a₂ | c₂ | f₂ |
| Stage₃ | a₃ | c₃ | f₃ |
| . . . | | | |
| Stageₙ | aₙ | cₙ | fₙ |

Here, aₙ is the average dispute amount of all disputes at stage n, cₙ is the count of all disputes at stage n, and fₙ is the fees to resolve the dispute at stage n.

Next, the scoring engine 122 computes normalized values based on Table 1 to generate the following Table 2:

TABLE 2
Scoring Inputs After Normalization

| | A_Norm | C_Norm | F_Norm | Sum_Norm | Weights |
|---|---|---|---|---|---|
| Stage₁ | A₁ | C₁ | F₁ | S₁ = A₁ + | W₁ = S₁/Sₘ |
| | | | | C₁ + F₁ | |
| Stage₂ | A₂ | C₂ | F₂ | S₂ = A₂ + | W₂ = S₂/Sₘ |
| | | | | C₂ + F₂ | |
| Stage₃ | A₃ | C₃ | F₃ | S₃ = A₃ + | W₂ = S₂/Sₘ |
| | | | | C₃ + F₃ | |
| . . . | | | | | |
| Stageₙ | Aₙ | Cₙ | Fₙ | Sₙ = Aₙ + | Wₙ = Sₙ/Sₘ |
| | | | | Cₙ + Fₙ | |

Here, A_norm is the normalized dispute amount between the minimum and maximum values, Weightₘᵢₙ and Weightₘₐₓ (e.g., an can range from $0.01 to $1,000, but Aₙ will be from 0.1 to 0.5). C_norm is the normalized count of resolved disputes between the minimum and maximum values (e.g., cₙ can range from 1 to 150,000, but Cₙ will be from 0.1 to 0.5). Likewise, F_norm is the normalized fees for the dispute resolution between the minimum and maximum values (e.g., fₙ can range from $0.5 to $500, but Fₙ will be from 0.1 to 0.5). In addition to the normalization of a, c, and f, the scoring engine 122 also computes Sum_norm, Sₙ, as the sum of the three normalized values of stage n. This sum is then used to compute a normalized weight, Wₙ, for each stage n. More specifically, Wₙ=Sₙ/Sₘ, where Sₘ=ΣSₙ.

In some examples, the scoring engine 122 implements dynamic changes to the weights, Wₙ, based on comparisons between predicted dispute scores 129 and actual outcomes of disputes. For example, the scoring engine 122 compares predicted scores against actual outcomes for the various disputes at each stage. In the case of high deviation, weights are recalculated. For example, if the predicted score for a given dispute is low but the issuer 110 won, then the weight of the stage is increased such that the predicted score is higher. If the predicted score is high but the issuer 110 lost, then the weight of the stage is decreased such that the predicted score is lower. During later scoring requests, the optimized weights may be used to generate improved scores.

In some examples, the scoring engine 122 uses a gradient descent function to adjust the weights, Wₙ. More specifically, an objective function J(W₁, Wₙ, . . . , Wₙ) is defined to minimize the deviation from the predicted score. The objective function is the squared difference between the predicted and target score:

$$J ( {W}_{1} , {W}_{n} , … , {W}_{n} ) = {( PredictedScore - TargetScore )}^{2} ,$$

where PredictedScore is the current predicted score calculated using the given weights and dispute counts (e.g., as in equation (1), above), and where TargetScore is the desired target score to achieve. Weights are updated iteratively until the objective function is minimized. In examples, the learning rate (e.g., step size) is 0.1, 0.05, 0.03, 0.02, 0.01 (e.g., configurable, decreases gradually), and maximum iterations=100 (e.g., also configurable). However, the optimization process may be stopped if the difference between two iterations is less than a predetermined percentage (e.g., 5%, also configurable).

In some examples, the scoring engine 122 performs periodic, automatic optimization of weightages over time. For example, presume that the scoring device 120 collects the dispute scores 129 for various disputes over time (e.g., over a one-month period, three-month period, or the like), and for the various layers of the disputes. At a later time, these dispute scores 129 (treated as “predictions” or “predicted scores” for those particular now-historical disputes) are then compared the actual outcomes of those disputes for each layer (treated as “actual scores” for those same disputes). In cases where the predicted scores highly deviate from the actual scores (at some particular layer), the scoring engine 122 recalculates the weight 212 for that layer. For example, if the predicted score for a particular layer is low but the issuer wins, then the weight 212 for that layer may be increased (such that future dispute scores 129 for that layer are higher). Likewise, if the predicted score is high but the issuer 110 loses, then the weight 212 of that layer may be lowered (such that future dispute scores 129 for that layer are lower). Such “optimized weights” may be used in lieu of default weights, and may be optimized specific to particular issuers, acquirers, issuer/acquirer pairs, or the like.

It should be noted that the dispute score 129 generated for a particular dispute is, in some respects, dynamic in nature. For example, in some situations, the scoring engine 122 may generate a higher dispute score for the issuer 110 at an earlier stage in the dispute resolution process, but that same dispute may cause the scoring engine 122 to generate a lower dispute score for the issuer 110 during a later stage in the process.

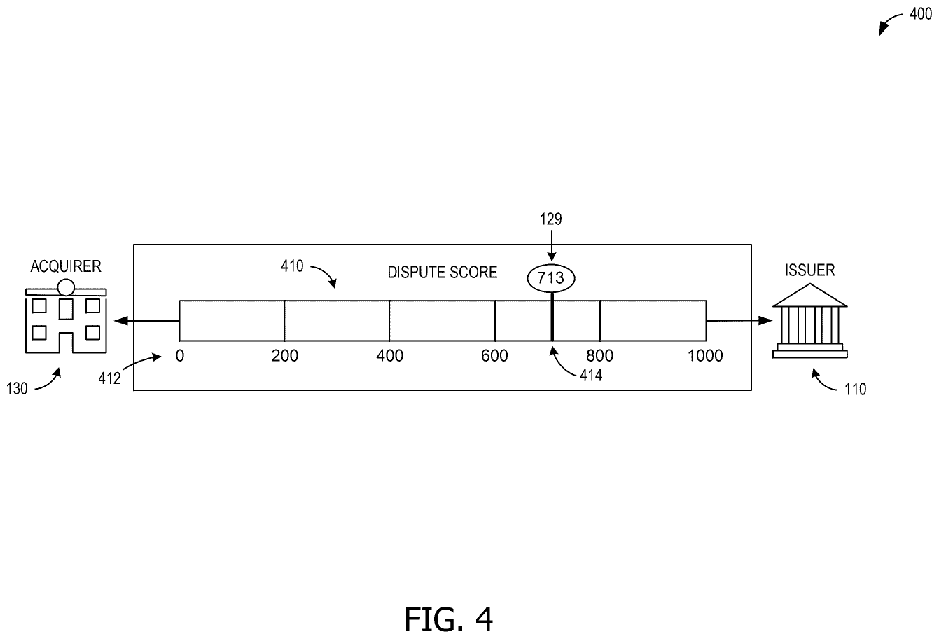

FIG. 4 is a diagram of an example graph 400 that displays the dispute score 129 on a dispute meter 410. In the example, the dispute meter 410 is a range plot onto which dispute score 129 of the chargeback 109 (e.g., as computed by the scoring engine 122) is plotted. The dispute meter 410 represents the range of the dispute scores 129 generated by the scoring engine 122, which in the above examples is a range of between 0 and 999 (as shown by range values 412), where lower scores favor the acquirer 130 and where higher scores favor the issuer 110. Here, the example dispute score 129 is a value of 713 and is plotted on the dispute meter 410 as plot line 414. In some examples, the dispute meter 410 is displayed to the issuer 110, the acquirer 130, or any of the stakeholder parties (e.g., via the UI 124).

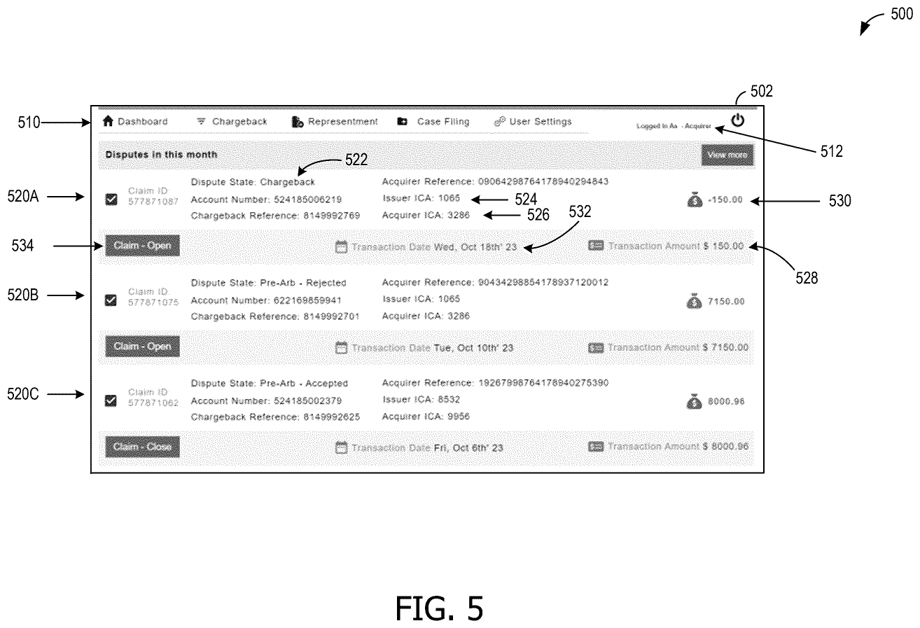

FIG. 5 is a screenshot 500 of an example dashboard 502 that shows several example disputes 520A-520C and associated data. In examples, the dashboard 502 is provided by the scoring device 120 via the UI 124 of FIG. 1 and to the issuer 110 and/or the acquirer 130. The dashboard 502 presents a dashboard menu 510 within which a user (e.g., the acquirer 130, as shown by party identifier 512) can select various menu options. In this example, the dashboard 502 currently displays a list of disputes 520A-520C, where each dispute 520A-520C may be associated with a disputed transaction such as chargeback request 109.

Each dispute 520A-520C, in the example, displays a current dispute stage 522 of that dispute, as well as a claim state 534 for the underlying chargeback request 109 (e.g., “Open”, “Closed”). Each dispute 520A-520C also displays an issuer ID 524 for the issuer 110 and an acquirer ID 526 for the acquirer 130 involved in the dispute. Further, some transaction data (e.g., for an underlying disputed transaction 103) is shown for each dispute 520A-520C, including a transaction date 532 and a transaction amount 528.

Additionally, the dashboard 502 also displays a current credited value 530 for each dispute 520A-520C. The current credited value 530 represents where the credit for the underlying disputed transaction 103 currently resides, and from the perspective of the party identifier 512. More specifically, in the example of dispute 520A, the user currently viewing the dashboard 502 is the acquirer 130 (e.g., “Logged In As—Acquirer”) and, at this “chargeback” stage (e.g., as shown by current dispute stage 522), the issuer 110 has been credited with the disputed transaction amount and the acquirer 130 has been debited. As such, the dashboard 502 presents the current credited value 530 as a negative value since, from the perspective of the acquirer 130 and merchant 104, the transaction amount 528 is currently not credited to the side of the acquirer 130. In situations where the current credited value 530 is on the side of the acquirer 130, the current credited value 530 is displayed as a positive value (e.g., as shown in dispute 520B). And conversely, when the issuer 110 is logged into the dashboard 502, the current credited value 530 for the same dispute 520A is displayed opposite that of the acquirer 130.

As such, the issuer 110 and/or acquirer 130 is able to view certain information about the various disputes 520A-520C via the dashboard 502 and the UI 124.

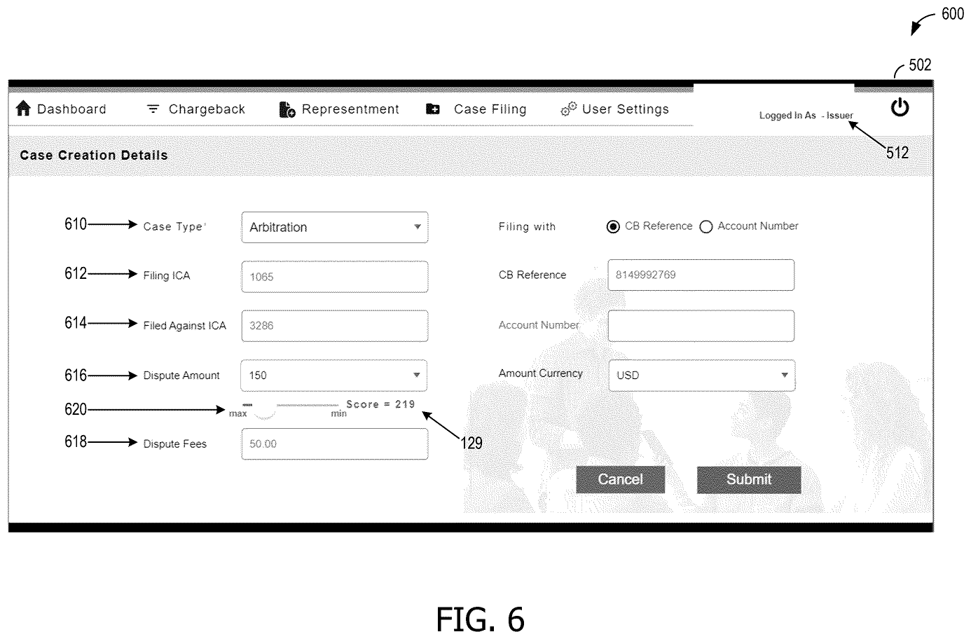

FIG. 6 is another screenshot 600 of the dashboard 502 in which the issuer 110 initiates an arbitration case for the example chargeback request 109 of FIG. 1. In the example, the dashboard 502 includes a case type field 610 (e.g., selected as “Arbitration” via a drop-down menu of options), a filing ICA field 612 (e.g., an identifier associated with the issuer 110), a filed against ICA field 614 (e.g., an identifier associated with the acquirer 130), a dispute amount field 616 (e.g., containing a value less than or equal to the transaction amount 528), and a dispute fees field 618 (e.g., containing a fee amount for filing this type of case).

In addition, in the example, the dashboard 502 also includes a score slider 620. This score slider 620 represents the dispute score 129, as computed by the scoring engine 122, and is currently set to a value of 219 in this example (e.g., favoring the acquirer 130 over the issuer 110). The dashboard 502 also displays the dispute score 129 next to the slider. As such, the slider 620 and display of the dispute score 129 allows the issuer 110 to consider and contemplate whether they really wish to continue filing an arbitration case based on their predicted changes of success.

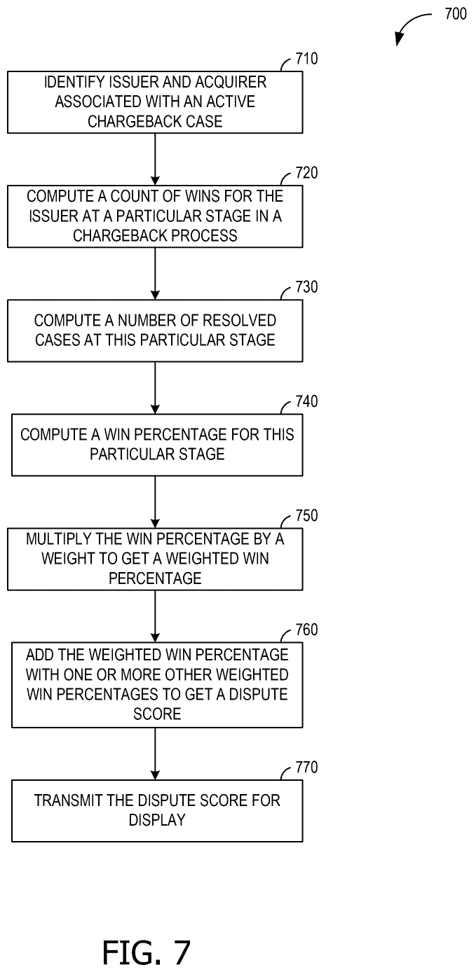

FIG. 7 is a flowchart of an example method 700 for analyzing and scoring dispute cases between parties such as the issuer 110 and the acquirer 130 of FIG. 1. In some examples, the method 700 is performed by the scoring device 120 within the dispute resolution system 100 of FIG. 1, and may include any of the operations described in FIG. 1 through FIG. 6. In the example, at operation 710, the scoring device 120 identifies an issuer (e.g., issuer 110) and an acquirer (e.g., acquirer 130) involved in an active dispute case (e.g., chargeback request 109) involving a payment transaction (e.g., disputed transaction 103).

At operation 720, in the example, the scoring device 120 causes to be computed, from a plurality of historical dispute cases between the issuer and the acquirer (e.g., from historical dispute database 108), a first count of wins (e.g., as in the issuer wins at this stage column 204) for the issuer at a first stage in a dispute resolution process (e.g., any of stages 220 to 232). In some examples, the scoring device 120 computes the first count of wins using data associated with the historical dispute cases. In other examples, the scoring device 120 transmits a query to the historical dispute database 108 that includes instructions to compute the first count of wins. At operation 730, the scoring device 120 causes to be computed, from the plurality of historical dispute cases, a number of resolved cases (e.g., as in the resolved at this stage column 206) at the first stage. Likewise, in some examples, the scoring device 120 performs this computation, where in other examples, a query is submitted to the historical dispute database 108 and another computing device performs this computation.

At operation 740, in the example, the scoring device 120 causes to be computed a first stage win percentage for the issuer (e.g., as in the win percentage column 210) based on the first count of wins and the number of resolved cases. In some examples, the first stage win percentage is computed as the first count of wins divided by the number of resolved cases at that stage. At operation 750, the scoring device 120 modifies the first stage win percentage by multiplying the first stage win percentage by a first weight value assigned to the first stage (e.g., as in weight column 212), thereby resulting in a weighted first stage win percentage (e.g., as in weighted win percentage column 214). At operation 760, the scoring device 120 adds the weighted first stage win percentage (e.g., the value of stage 224 in column 214) with at least one other weighted win percentage for at least one other stage (e.g., any or all of the weighted win percentages in column 214 for the other stages 220, 222, and 226 to 232), thereby resulting in a dispute score (e.g., dispute score 129). At operation 770, the scoring device 120 transmits the dispute score for display to one of the issuer and the acquirer, the dispute score representing a likelihood of one of the issuer and the acquirer in prevailing in the active dispute case over the other of the issuer and the acquirer.

In some examples, the scoring device 120 also computes a weighted win percentage for a plurality of stages of the dispute resolution process, and adds the weighted first stage win percentage with at least one other weighted win percentage further includes summing all of the weighted win percentages of the plurality of stages to determine the dispute score. In some examples, the scoring device 120 also normalizes the dispute score to a predefined range (e.g., range 412), causes a graph (e.g., graph 400) to be displayed to one or more of the issuer and the acquirer, the graph including the predefined range in a first dimension, and displays the dispute score within the predefined range on the graph.

In some examples, the scoring device 120 automatically cancels or concedes the active dispute case in favor of one of the issuer and the acquirer when the dispute score exceeds a predetermined threshold. In some examples, the scoring device 120 receives a scoring request message from a computing device associated with an issuer of a payment instrument associated with the active dispute case, the scoring request message including one or more of an identifier of the active dispute case, an identifier of the issuer, and an identifier of an acquirer associated with the payment transaction, and wherein transmitting the dispute score for display further comprises transmitting, to the computing device associated with the issuer, the dispute score and one or more of the first count of wins, the number of resolved cases, the first stage win percentage, the weighted first stage win percentage associated with the first stage of the dispute resolution process, and a current stage of the active dispute case.

In some examples, the scoring device 120 reads a plurality of weights, each weight of the plurality of weights being associated with a particular stage of the dispute resolution process, the plurality of weights including the first weight value, and automatically adjusts, changes, or recomputes the first weight value assigned to the first stage based on a gradient descent function that uses predictions of historical dispute cases and actual outcomes of those historical dispute cases. In some examples, the first weight value is computed based on one or more of an average dispute amount of all the historical dispute cases at the first stage, a count of all disputes resolved at the first stage, and an amount of fees paid to resolve the disputes at the first stage.

### Exemplary Operating Environment

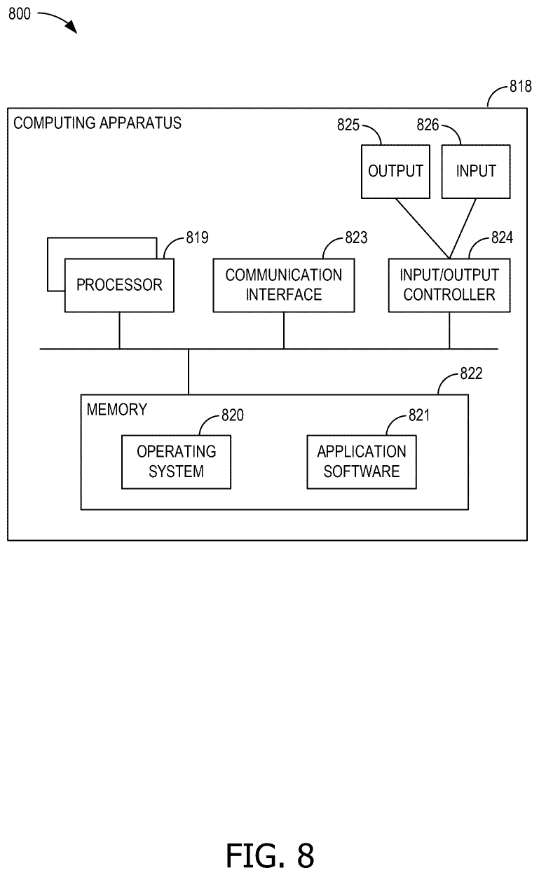

The present disclosure is operable with a computing apparatus according to an embodiment as a functional block diagram 800 in FIG. 8. In an example, components of a computing apparatus 818 are implemented as a part of an electronic device according to one or more embodiments described in this specification. The computing apparatus 818 is a computing device, such as, but not limited to, the scoring device 120, the issuer device 112, the acquirer device 132, the historical dispute database 108, the consumer device 107, or the merchant device 105 of FIG. 1.

The computing apparatus 818 comprises one or more processors 819 which can be microprocessors, controllers, or any other suitable type of processors for processing computer executable instructions to control the operation of the electronic device. Alternatively, or in addition, the processor 819 is any technology capable of executing logic or instructions, such as a hardcoded machine. In some examples, platform software comprising an operating system 820 or any other suitable platform software is provided on the apparatus 818 to enable application software 821 to be executed on the device.

In some examples, computer executable instructions are provided using any computer-readable medium or media accessible by the computing apparatus 818. Computer-readable media include, for example, computer storage media such as a memory 822 and communications media. Computer storage media, such as a memory 822, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium does not include a propagating signal. Propagated signals per se are not examples of computer storage media. Although the computer storage medium (the memory 822) is shown within the computing apparatus 818, it will be appreciated by a person skilled in the art, that, in some examples, the storage is distributed or located remotely and accessed via a network or other communication link (e.g., using a communication interface 823).

Further, in some examples, the computing apparatus 818 comprises an input/output controller 824 configured to output information to one or more output devices 825, for example a display or a speaker, which are separate from or integral to the electronic device. Additionally, or alternatively, the input/output controller 824 is configured to receive and process an input from one or more input devices 826, for example, a keyboard, a microphone, or a touchpad. In one example, the output device 825 also acts as the input device. An example of such a device is a touch sensitive display. The input/output controller 824 in other examples outputs data to devices other than the output device, e.g., a locally connected printing device. In some examples, a user provides input to the input device(s) 826 and/or receives output from the output device(s) 825.

The functionality described herein can be performed, at least in part, by one or more hardware logic components. The computing apparatus 818 is configured by the program code when executed by the processor 819 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

### ADDITIONAL EXAMPLES

In some examples, a dispute scoring system is provided. The dispute scoring system includes at least one processor; and at least one memory comprising computer-readable instructions, the at least one processor, the at least one memory and the computer-readable instructions configured to cause the at least one processor to: identify a first party and a second party involved in an active dispute case involving a payment transaction; generate, from a plurality of historical dispute cases between the first party and the second party, a first count of wins for the first party at a first stage in a dispute resolution process; generate, from the plurality of historical dispute cases, a number of resolved cases at the first stage; compute a first stage win percentage for the first party based on the first count of wins and the number of resolved cases; weight the first stage win percentage by a first weight value assigned to the first stage, thereby resulting in a weighted first stage win percentage; combine the weighted first stage win percentage with at least one other weighted win percentage for at least one other stage, thereby resulting in a dispute score; and transmit the dispute score for display to one of the first party and the second party, the dispute score representing a likelihood of one of the first and second party in prevailing in the active dispute case over the other of the first and second party.

In another example, a computer-implemented method is provided. The method includes: identifying an issuer and an acquirer involved in an active dispute case involving a payment transaction; causing to be computed, from a plurality of historical dispute cases between the issuer and the acquirer, a first count of wins for the issuer at a first stage in a dispute resolution process; causing to be computed, from the plurality of historical dispute cases, a number of resolved cases at the first stage; causing to be computed a first stage win percentage for the issuer based on the first count of wins and the number of resolved cases; modifying the first stage win percentage by multiplying by a first weight value assigned to the first stage, thereby resulting in a weighted first stage win percentage; adding the weighted first stage win percentage with at least one other weighted win percentage for at least one other stage, thereby resulting in a dispute score; and transmitting the dispute score for display to one of the issuer and the acquirer, the dispute score representing a likelihood of one of the issuer and the acquirer in prevailing in the active dispute case over the other of the issuer and the acquirer.

In still other examples, a computer storage medium is provided. The computer storage medium has computer-executable instructions that, upon execution by a processor of a computer, cause the processor to at least: identify a first party and a second party involved in an active dispute case involving a payment transaction; generate, from a plurality of historical dispute cases between the first party and the second party, a first count of wins for the first party at a first stage in a dispute resolution process; generate, from the plurality of historical dispute cases, a number of resolved cases at the first stage; compute a first stage win percentage for the first party based on the first count of wins and the number of resolved cases; weight the first stage win percentage by a first weight value assigned to the first stage, thereby resulting in a weighted first stage win percentage; combine the weighted first stage win percentage with at least one other weighted win percentage for at least one other stage, thereby resulting in a dispute score; and transmit the dispute score for display to one of the first party and the second party, the dispute score representing a likelihood of one of the first and second party in prevailing in the active dispute case over the other of the first and second party.

Alternatively, or in addition to the other examples described herein, examples include any combination of the following:
identify a first party and a second party involved in an active dispute case involving a payment transaction;
a first party is an issuing bank, or issuer;
a second party is an acquiring bank, or acquirer;
generate, from a plurality of historical dispute cases between the first party and the second party, a first count of wins for the first party at a first stage in a dispute resolution process;
generate, from the plurality of historical dispute cases, a number of resolved cases at the first stage;
compute a first stage win percentage for the first party based on the first count of wins and the number of resolved cases;
weight the first stage win percentage by a first weight value assigned to the first stage, thereby resulting in a weighted first stage win percentage;
combine the weighted first stage win percentage with at least one other weighted win percentage for at least one other stage, thereby resulting in a dispute score;
transmit the dispute score for display to one of the first party and the second party, the dispute score representing a likelihood of one of the first and second party in prevailing in the active dispute case over the other of the first and second party;
compute a weighted win percentage for a plurality of stages of the dispute resolution process;
combining the weighted first stage win percentage with at least one other weighted win percentage includes summing all of the weighted win percentages of the plurality of stages to determine the dispute score;
normalize the dispute score to a predefined range;
cause a graph and/or a weighted score to be displayed to one or more of the first and second parties, the graph including the predefined range in a first dimension;
display the dispute score within the predefined range on the graph;
automatically concede the active dispute case in favor of one of the first and second parties when the dispute score exceeds a predetermined threshold;
receive a scoring request message from a computing device associated with an issuer of a payment instrument associated with the active dispute case;
a scoring request message identifying one or more of an identifier of the active dispute case, an identifier of the issuer, and an identifier of an acquirer associated with the payment transaction;
transmitting a dispute score for display comprises transmitting, to the computing device associated with one of an issuer and an acquirer, the dispute score and one or more of the first count of wins, the number of resolved cases, the first stage win percentage, the weighted first stage win percentage associated with the first stage of the dispute resolution process, and a current stage of the active dispute case;
identify a plurality of initial predefined weights, each initial predefined weight of the plurality of initial predefined weights being associated with a particular stage of the dispute resolution process, the plurality of initial predefined weights including the first weight value;
automatically change the first weight value assigned to the first stage using a gradient descent function based on predictions of historical dispute cases and actual outcomes of those historical dispute cases;
the first weight value is computed based on one or more of an average dispute amount of all the historical dispute cases at the first stage, a count of all disputes resolved at the first stage, and an amount of fees paid to resolve the disputes at the first stage;
identifying an issuer and an acquirer involved in an active dispute case involving a payment transaction;
causing to be computed, from a plurality of historical dispute cases between the issuer and the acquirer, a first count of wins for the issuer at a first stage in a dispute resolution process;
causing to be computed, from the plurality of historical dispute cases, a number of resolved cases at the first stage;
causing to be computed a first stage win percentage for the issuer based on the first count of wins and the number of resolved cases;
modifying the first stage win percentage by multiplying by a first weight value assigned to the first stage, thereby resulting in a weighted first stage win percentage;
adding the weighted first stage win percentage with at least one other weighted win percentage for at least one other stage, thereby resulting in a dispute score;
transmitting the dispute score for display to one of the issuer and the acquirer, the dispute score representing a likelihood of one of the issuer and the acquirer in prevailing in the active dispute case over the other of the issuer and the acquirer;
generating the first count of wins further includes excluding one or more historical dispute cases between the first party and the second party based on one or more filter parameters;
computing a weighted win percentage for a plurality of stages of the dispute resolution process;
adding the weighted first stage win percentage with at least one other weighted win percentage further includes summing all of the weighted win percentages of the plurality of stages to determine the dispute score;
normalizing the dispute score to a predefined range;
causing a graph to be displayed to one or more of the issuer and the acquirer, the graph including the predefined range in a first dimension;
display the dispute score within the predefined range on the graph;
automatically cancelling the active dispute case in favor of one of the issuer and the acquirer when the dispute score exceeds a predetermined threshold;
receiving a scoring request message from a computing device associated with an issuer of a payment instrument associated with the active dispute case, the scoring request message including one or more of an identifier of the active dispute case, an identifier of the issuer, and an identifier of an acquirer associated with the payment transaction;
transmitting the dispute score for display further comprises transmitting, to the computing device associated with the issuer, the dispute score and one or more of the first count of wins, the number of resolved cases, the first stage win percentage, the weighted first stage win percentage associated with the first stage of the dispute resolution process, and a current stage of the active dispute case;
reading a plurality of weights, each weight of the plurality of weights being associated with a particular stage of the dispute resolution process, the plurality of weights including the first weight value;
automatically adjusting the first weight value assigned to the first stage based on a gradient descent function that uses predictions of historical dispute cases and actual outcomes of those historical dispute cases; and
the first weight value is computed based on one or more of an average dispute amount of all the historical dispute cases at the first stage, a count of all disputes resolved at the first stage, and an amount of fees paid to resolve the disputes at the first stage.

Any range or device value given herein may be extended or altered without losing the effect sought, as will be apparent to the skilled person.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent can take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for identifying an issuer and an acquirer involved in an active dispute case involving a payment transaction; exemplary means for causing to be computed, from a plurality of historical dispute cases between the issuer and the acquirer, a first count of wins for the issuer at a first stage in a dispute resolution process; exemplary means for causing to be computed, from the plurality of historical dispute cases, a number of resolved cases at the first stage; exemplary means for causing to be computed a first stage win percentage for the issuer based on the first count of wins and the number of resolved cases; exemplary means for modifying the first stage win percentage by multiplying by a first weight value assigned to the first stage, thereby resulting in a weighted first stage win percentage; exemplary means for adding the weighted first stage win percentage with at least one other weighted win percentage for at least one other stage, thereby resulting in a dispute score; and exemplary means for transmitting the dispute score for display to one of the issuer and the acquirer, the dispute score representing a likelihood of one of the issuer and the acquirer in prevailing in the active dispute case over the other of the issuer and the acquirer.

At least a portion of the functionality of the various elements in FIG. 1 to FIG. 8 can be performed by other elements in FIG. 1 to FIG. 8, or an entity (e.g., processor, web service, server, application program, computing device, etc.) not shown in FIG. 1 to FIG. 8.

In some examples, the operations illustrated in FIG. 1 through FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Within the scope of this application, it is expressly intended that the various aspects, embodiments, examples, and alternatives set out in the preceding paragraphs, in the claims and/or in the description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim, accordingly, including the right to amend any originally filed claim to depend from and/or incorporate any feature of any other claim although not originally claimed in that manner.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A dispute scoring system comprising:
at least one processor; and
at least one memory comprising computer-readable instructions, the at least one processor, the at least one memory and the computer-readable instructions configured to cause the at least one processor to:
identify a first party and a second party involved in an active dispute case involving a payment instrument transaction;
generate, from a plurality of historical dispute cases between the first party and the second party, a first count of wins for the first party at a first stage in a dispute resolution process;
generate, from the plurality of historical dispute cases, a number of resolved cases at the first stage;
compute a first stage win percentage for the first party based on the first count of wins and the number of resolved cases;
weight the first stage win percentage by a first weight value assigned to the first stage, thereby resulting in a weighted first stage win percentage;
combine the weighted first stage win percentage with at least one other weighted win percentage for at least one other stage, thereby resulting in a dispute score; and
cause display of the dispute score to one of the first party and the second party, the dispute score representing a likelihood of one of the first and second party in prevailing in the active dispute case over the other of the first and second party.

2. The dispute scoring system of claim 1, wherein the computer-readable instructions are further configured to cause the at least one processor to:
compute a weighted win percentage for a plurality of stages of the dispute resolution process,
wherein combining the weighted first stage win percentage with at least one other weighted win percentage further includes summing all the weighted win percentages of the plurality of stages to determine the dispute score.

3. The dispute scoring system of claim 1, wherein the computer-readable instructions are further configured to cause the at least one processor to:
normalize the dispute score to a predefined range;
cause a graph to be displayed to one or more of the first and second parties, the graph including the predefined range in a first dimension; and
display the dispute score within the predefined range on the graph.

4. The dispute scoring system of claim 1, wherein the computer-readable instructions are further configured to cause the at least one processor to:
automatically concede the active dispute case in favor of one of the first and second parties when the dispute score exceeds a predetermined threshold.

5. The dispute scoring system of claim 1, wherein the computer-readable instructions are further configured to cause the at least one processor to:
receive a scoring request message from a computing device associated with an issuer of a payment instrument associated with the active dispute case, the scoring request message identifying one or more of an identifier of the active dispute case, an identifier of the issuer, and an identifier of an acquirer associated with the payment instrument transaction,
wherein transmitting the dispute score for display further comprises transmitting, to the computing device associated with the issuer, the dispute score and one or more of the first count of wins, the number of resolved cases, the first stage win percentage, the weighted first stage win percentage associated with the first stage of the dispute resolution process, and a current stage of the active dispute case.

6. The dispute scoring system of claim 1, wherein the computer-readable instructions are further configured to cause the at least one processor to:
identify a plurality of initial predefined weights, each initial predefined weight of the plurality of initial predefined weights being associated with a particular stage of the dispute resolution process, the plurality of initial predefined weights including the first weight value; and
automatically change the first weight value assigned to the first stage using a gradient descent function based on predictions of historical dispute cases and actual outcomes of those historical dispute cases.

7. The dispute scoring system of claim 6, wherein the first weight value is computed based on one or more of an average dispute amount of all the historical dispute cases at the first stage, a count of all disputes resolved at the first stage, and an amount of fees paid to resolve the disputes at the first stage.

8. A computer-implemented method comprising:
identifying an issuer and an acquirer involved in an active dispute case involving a payment instrument transaction;
causing to be computed, from a plurality of historical dispute cases between the issuer and the acquirer, a first count of wins for the issuer at a first stage in a dispute resolution process;
causing to be computed, from the plurality of historical dispute cases, a number of resolved cases at the first stage;
causing to be computed a first stage win percentage for the issuer based on the first count of wins and the number of resolved cases;
modifying the first stage win percentage by multiplying by a first weight value assigned to the first stage, thereby resulting in a weighted first stage win percentage;
adding the weighted first stage win percentage with at least one other weighted win percentage for at least one other stage, thereby resulting in a dispute score; and
transmitting the dispute score for display to one of the issuer and the acquirer, the dispute score representing a likelihood of one of the issuer and the acquirer in prevailing in the active dispute case over the other of the issuer and the acquirer.

9. The computer-implemented method of claim 8, further comprising:
computing a weighted win percentage for a plurality of stages of the dispute resolution process,
wherein adding the weighted first stage win percentage with at least one other weighted win percentage further includes summing all the weighted win percentages of the plurality of stages to determine the dispute score.

10. The computer-implemented method of claim 8, further comprising:
normalizing the dispute score to a predefined range;
causing a graph to be displayed to one or more of the issuer and the acquirer, the graph including the predefined range in a first dimension; and
displaying the dispute score within the predefined range on the graph.

11. The computer-implemented method of claim 8, further comprising:
automatically cancelling the active dispute case in favor of one of the issuer and the acquirer when the dispute score exceeds a predetermined threshold.

12. The computer-implemented method of claim 8, further comprising:
receiving a scoring request message from a computing device associated with an issuer of a payment instrument associated with the active dispute case, the scoring request message including one or more of an identifier of the active dispute case, an identifier of the issuer, and an identifier of an acquirer associated with the payment instrument transaction,
wherein transmitting the dispute score for display further comprises transmitting, to the computing device associated with the issuer, the dispute score and one or more of the first count of wins, the number of resolved cases, the first stage win percentage, the weighted first stage win percentage associated with the first stage of the dispute resolution process, and a current stage of the active dispute case.

13. The computer-implemented method of claim 8, further comprising:
reading a plurality of weights, each weight of the plurality of weights being associated with a particular stage of the dispute resolution process, the plurality of weights including the first weight value; and
automatically adjusting the first weight value assigned to the first stage based on a gradient descent function that uses predictions of historical dispute cases and actual outcomes of those historical dispute cases.

14. The computer-implemented method of claim 13, wherein the first weight value is computed based on one or more of an average dispute amount of all the historical dispute cases at the first stage, a count of all disputes resolved at the first stage, and an amount of fees paid to resolve the disputes at the first stage.

15. A computer storage medium having computer-executable instructions that, upon execution by a processor of a computer, cause the processor to at least:
identify a first party and a second party involved in an active dispute case involving a payment instrument transaction;
generate, from a plurality of historical dispute cases between the first party and the second party, a first count of wins for the first party at a first stage in a dispute resolution process;
generate, from the plurality of historical dispute cases, a number of resolved cases at the first stage;
compute a first stage win percentage for the first party based on the first count of wins and the number of resolved cases;
weight the first stage win percentage by a first weight value assigned to the first stage, thereby resulting in a weighted first stage win percentage;
combine the weighted first stage win percentage with at least one other weighted win percentage for at least one other stage, thereby resulting in a dispute score; and
transmit the dispute score for display to one of the first party and the second party, the dispute score representing a likelihood of one of the first and second party in prevailing in the active dispute case over the other of the first and second party.

16. The computer storage medium of claim 15, wherein the computer-executable instructions, when executed by a processor of the computer, further cause the computer to:
compute a weighted win percentage for a plurality of stages of the dispute resolution process,
wherein combining the weighted first stage win percentage with at least one other weighted win percentage further includes summing all the weighted win percentages of the plurality of stages to determine the dispute score.

17. The computer storage medium of claim 15, wherein the computer-executable instructions, when executed by a processor of the computer, further cause the computer to:
normalize the dispute score to a predefined range;
cause a graph to be displayed to one or more of the first and second parties, the graph including the predefined range in a first dimension; and
display the dispute score within the predefined range on the graph.

18. The computer storage medium of claim 15, wherein generating the first count of wins further includes excluding one or more historical dispute cases between the first party and the second party based on one or more filter parameters.

19. The computer storage medium of claim 15, wherein the computer-executable instructions, when executed by a processor of the computer, further cause the computer to:
receive a scoring request message from a computing device associated with an issuer of a payment instrument associated with the active dispute case, the scoring request message identifying one or more of an identifier of the active dispute case, an identifier of the issuer, and an identifier of an acquirer associated with the payment instrument transaction,
wherein transmitting the dispute score for display further comprises transmitting, to the computing device associated with the issuer, the dispute score and one or more of the first count of wins, the number of resolved cases, the first stage win percentage, the weighted first stage win percentage associated with the first stage of the dispute resolution process, and a current stage of the active dispute case.

20. The computer storage medium of claim 15, wherein the computer-executable instructions, when executed by a processor of the computer, further cause the computer to:
identify a plurality of initial predefined weights, each initial predefined weight of the plurality of initial predefined weights being associated with a particular stage of the dispute resolution process, the plurality of initial predefined weights including the first weight value; and
automatically change the first weight value assigned to the first stage using a gradient descent function based on predictions of historical dispute cases and actual outcomes of those historical dispute cases.
